(19) United States
(12) Patent Application Publication
(10) Pub. No.: US 2003/0214446 A1
(43) Pub. Date: Nov. 20, 2003

(54) Diversity gain antenna

(76) Inventor: Imad Shehab, San Diego, CA (US)

Correspondence Address: Kenneth J. Cool, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/144,966

(22) Filed: May 14, 2002

(51) Int. Cl. H01Q 1/24

(52) U.S. Cl. 343/702

(57) ABSTRACT

A diversity antenna exhibits a diversity gain pattern. The diversity gain pattern is provided as a combination of the gain patterns of first and second antennas. The first antenna has a ground plane that is disposed orthogonally with respect to the ground plane of the second antenna. In one arrangement of the invention, the first and second antennas are printed inverted F antenna structures, and may be disposed on a common circuit board substrate. The invention includes a device that incorporates the diversity gain antenna and may be disposed in a wireless local area network device. A diversity switch and a transmit and receive switch are provided to couple the diversity antenna to a baseband transceiver. The device may optionally include a processor to couple with the baseband transceiver, and may optionally couple with a host processor disposed in a host device to operate with the device having a diversity antenna in accordance with the invention.

### DESCRIPTION OF THE DRAWING FIGURES

The present invention may be understood by those skilled in the art by reference to the accompanying figures in which:

FIG. 1 is an isometric view of a diversity gain antenna structure in accordance with the present invention;

FIGS. 2A and 2B are example X-Y cuts of the antenna patterns of the diversity gain antenna structure of FIG. 1 in accordance with the present invention; and

FIG. 3 is a block diagram of a device utilizing a diversity gain antenna structure in accordance with the present invention.

### DETAILED DESCRIPTION

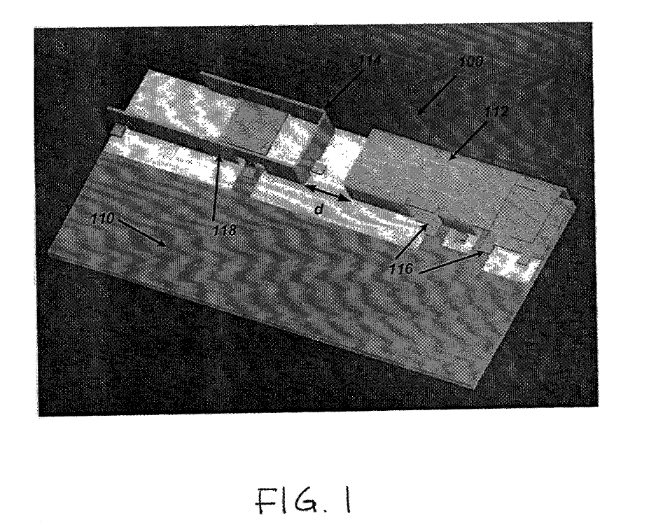

Referring now to FIG. 1, a diversity gain antenna in accordance with the present invention will be discussed. Diversity gain antenna 100 comprises two antenna structures disposed on a printed circuit board (PCB) 110. In one embodiment of the invention, antennas 112 and 114 each are characterized by having a printed inverted F antenna (PIFA) structure. In general, a PIFA structure may consist of four basic elements including a ground plane, a top plate element, a feed strip to connect the ground plane to the top plate element, and a shorting strip to short the top plate to the ground plane. Typically, a PIFA structure consists of the above four basic elements or alternatively a variation thereof such as an additional ground element, and in some cases a puck for mechanical support which may be fabricated from a plastic material, for example. With a typical PIFA structure, an RF trace connects at an input of the antenna base, the feed, and energy provided to PIFA structure is launched from the plate with the ground strip providing a return path. A PIFA structure may be optionally provided with many variations, including but not limited to the dimensions of the top plate including height, width, and length, the width of the shorting leg, and the relative location of the feed. It should be noted that although antennas 112 and 114 may be provided having a PIFA structure in the example shown, antennas 112 and 114 could alternatively be constructed using any other suitable antenna structure in accordance with the present invention. In at least one alternative embodiment, a suitable antenna structure may include a structure where each antenna has a ground plane that may be orthogonally disposed with respect to the ground plane of the other antenna.

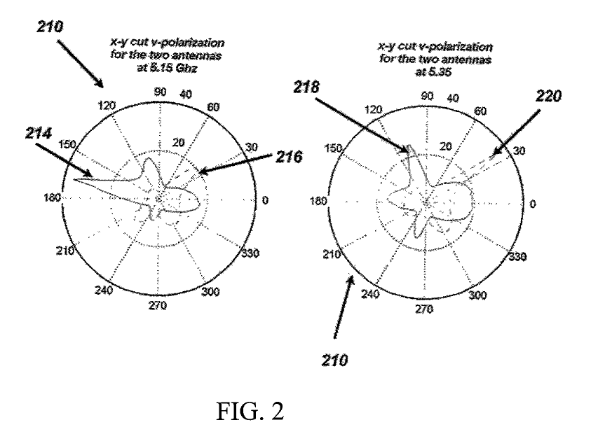

As utilized herein, the term diversity in at least one embodiment may refer to, but need not be limited to, the utilization of two antennas 112 and 114 in a complementary manner to enhance the overall performance of antenna 100 when antennas 112 and 114 are utilized in combination. Likewise, the term diversity gain as utilized herein may refer to in at least one embodiment, the utilization of complementary or approximately complimentary gain patterns of two antennas 112 and 114 in order to provide an overall enhancement of the performance of antenna 100 when the gain patterns of antennas 112 and 114 are combined. Such an enhancement of performance includes, but is not limited to, utilization of the gain pattern of one antenna to fill at least one or more nulls in the gain pattern of the other antenna so that the overall combined gain pattern has reduced or eliminated null patterns compared to the nulls in the gain patterns of either of the two antennas. An antenna having such an enhanced overall gain pattern can be referred to as being omnidirectional or at least more omnidirectional in combination, in other words having a more uniform gain pattern, than either of the two antennas 112 and 114 individually. Such an enhanced gain pattern is shown in and described with respect to FIG. 2.

As shown in FIG. 1, antenna 100 comprises a first antenna 112 disposed on a printed circuit board 110 wherein antenna 112 has a ground plane 116 that is disposed in a parallel relationship with respect to printed circuit board 110. Antenna 100 further comprises a second antenna 114 disposed on printed circuit board 110 wherein antenna 114 has a ground plane 118 that is disposed in a perpendicular relationship with respect to printed circuit board 110. By disposing one antenna in a perpendicular relationship with respect to a reference plane, for example printed circuit board 110, and disposing the other antenna in a parallel relationship with respect to the reference plane, the ground planes of each of the antennas may be considered to be orthogonally disposed with respect to one another. Antennas 112 and 114 are coupled to a common source such as a transmitter, receiver, transceiver, and so on, so that the gain patterns of each of antennas 112 and 114 combine via superpositioning to result in a diversity gain antenna 100 having an overall gain pattern that is the resulting combination of each of the gain patterns attributable to antenna 112 and 114 in combination. In one embodiment of the invention, antennas 112 and 114, and therefore also diversity gain antenna 100, are tuned for operation at a frequency or frequency and signals in compliance with a wireless local area network (wireless LAN or WLAN) as promulgated by the Institute of Electrical and Electronics Engineers (IEEE), for example the IEEE 802.11b (wireless fidelity or Wi-Fi) standard, the IEEE 802.11a standard, the IEEE 802.11g standard, and so on. Alternatively, antennas 112 and 114 may be optimized for operation at various other frequencies or communications standards, such as a standard promulgated by the Bluetooth Special Interest Group (Bluetooth) without departing from the scope of the invention and without providing substantial change thereto.

Referring now to FIGS. 2A and 2B, antenna gain patterns for diversity gain antenna in accordance with the present invention will be discussed. FIG. 2A shows an example X-Y cut vertical-polarization gain pattern 210 for diversity gain antenna 100 at 5.15 GHz, and FIG. 2B shows an example X-Y cut vertical-polarization gain pattern 212 for diversity gain antenna 100 at 5.35 GHz. As shown for example in FIG. 2A, the gain patterns 214 and 216 are approximately orthogonal to one another so that a peak in gain pattern 216 appears approximately at a node of gain pattern 214, and vice-versa. Likewise, as can shown for example in FIG. 2B, the gain patterns 218 and 220 are approximately orthogonal to one another so that a peak in gain pattern 220 appears approximately at a node of gain pattern 218, and vice-versa. The orthogonal gain patterns exhibited by diversity gain antenna 100 may result from the fact that antenna 112 and antenna 114 are disposed orthogonally, or at least approximately orthogonally, with respect to one another on printed circuit board 110. In addition, the distance d at which antenna 112 and antenna 114 are disposed apart from one another is selected to maintain a predetermined amount of electrical isolation between antennas 112 and 114. In one embodiment, the distance d is selected to provide an electrical isolation of at least 12 dB between antenna 112 and antenna 114. In an alternative embodiment, the distance d is selected to provide an electrical isolation of at least 20 dB between antenna 112 and antenna 114. In other embodiments, the distance d is selected to provide lesser electrical isolation between antenna 112 and antenna 114, for example, any amount less than 12 dB, and in yet further embodiments, any amount greater than 12 dB. In another embodiment, the distance d is selected according to a desired amount of electrical isolation, which can be any specified number of decibels, for example. The distance d in one embodiment may be selected according to a required isolation figure, for example greater than 20 dB. In an alternative embodiment, the distance d may be selected according to the amount of area or estate allocated for the design of antenna 100. In yet another embodiment, antennas 112 and 114 may be separated at a distance d such that the two received signals at antennas 112 and 114, respectively, are uncorrelated with each other to provide spatial diversity as well, where another diversity scheme is provided to account for a selected amount of diversity. Any one of the factors affecting distance d may be accounted for individually or in combination of one or more factors to provide a selected distanced.

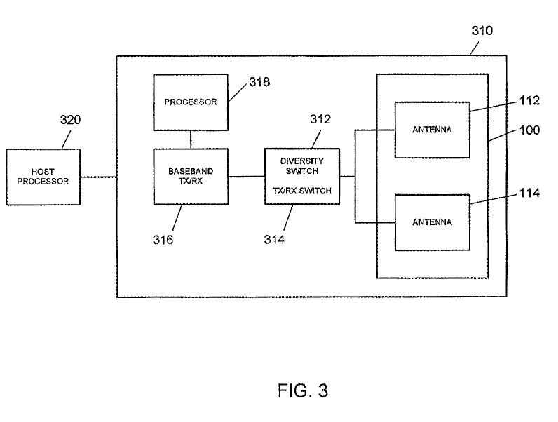

Referring now to FIG. 3, a block diagram of a device utilizing a diversity gain antenna in accordance with the present invention will be discussed. Device 310 includes antenna 112 and antenna 114 in a diversity gain antenna arrangement in accordance with the present invention as discussed herein. Antenna 112 and antenna 114 couple with a diversity switch 312 to control the diversity operation of antennas 112 and 114 in a diversity antenna arrangement. Diversity switch 312 couples with a transmit and receive switch (Tx/Rx Switch) 314, alternatively referred to as a transceiver switch, to control transmission and receiving operation via antennas 112 and 114. In one embodiment of the invention, diversity switch 312 and Tx/Rx switch 314 may be combined into a single switch having four ports to provide the functions of both diversity switch 312 and Tx/Rx switch 314. In one embodiment, Tx/Rx switch 314, or the combined switch, couples with a baseband transceiver 316 to provide transmission and/or reception of signals via diversity antennas 112 and 114. It should be noted that the functional blocks of device 310 are for illustrative purposes only and do not necessarily illustrate a direct correspondence to the silicon chips on which particular functions may reside. For example, a general architecture of device 310 where device 310 is a wireless device may include three chip systems, including a baseband processor, a radio transceiver, and a front end that may include a power amplifier (PA), a low noise amplifier (LNA), one or more filters, one or more switches, and at least one antenna. One embodiment of the invention may provide a two-chip architecture by combining the front-end components with a transceiver in a first chip, and provide a baseband processor in a second chip. In an alternative embodiment, the baseband processor, transceiver, and power amplifier a provided each in a separate chip. In yet another embodiment, a single chip solution may be provided. Such a single chip solution may correspond more directly with baseband transceiver 316. In one particular embodiment, baseband transceiver 316 may be a transmitter, a receiver, or a combined transmitter and receiver, and may optionally further include any other transceiver components such as the power amplifier, filters, low noise amplifiers, switches, and so on. In yet a further embodiment, baseband transceiver 316 and diversity switch 312 and transceiver switch 314 may all be provided on a single chip. Device 310 optionally includes a processor 318 to couple with baseband transmitter 316 to execute programs or otherwise run software instructions to control the operation of device 310. Device 310 may be, for example, a wide area local area network (WLAN) module or card, and may be housed in a personal computer card (PC card) housing or otherwise be disposed in a base station, an access point, or a user equipment device such as a personal digital assistant (PDA), a cellular telephone, or a wireless router, for example. In one embodiment, such as where device is disposed in an expansion module or PC card module, device 310 maybe disposed or capable of being disposed in a host device and may couple with a host processor 320 of the host device. Such a host device may be a portable personal computer having a PC card slot where device 310 is a PC card module to couple with the personal computer in the PC card slot. Diversity gain antenna 310 may be likewise utilized in any other device, module, housing, computer, PDA, vehicle, and so on, without departing from the scope of the invention and without providing substantial change thereto.

Although the invention has been described with a certain degree of particularity, it should be recognized that elements thereof may be altered by persons skilled in the art without departing from the spirit and scope of the invention. It is believed that the diversity gain antenna, and apparatuses incorporating a diversity gain antenna, of the present invention will be understood by the forgoing description, and it will be apparent that various changes may be made in the form, construction and arrangement of the components thereof without departing from the scope and spirit of the invention or without sacrificing all of its material aspects, the form herein before described being merely an explanatory embodiment or embodiments thereof, and further without providing substantial change thereto. It is the intention of the claims to encompass and include such changes.

What is claimed is:

1. An apparatus, comprising:
a first antenna having a ground plane; and
a second antenna having a ground plane;
the first and second antennas being disposed with respect to one another wherein the ground plane of the first antenna and the ground plane of the second antenna each are disposed orthogonally with respect to each other to provide complementary gain patterns combined into an overall diversity gain pattern.

2. An apparatus as claimed in claim 1, said first and second antennas being disposed on a common printed circuit board.

3. An apparatus as claimed in claim 1, at least one of said first and second antennas comprising a printed inverted F antenna.

4. An apparatus as claimed in claim 1, at least one relative maximum of one of the gain patterns the occurring at an angle corresponding to a null of the other gain pattern.

5. An apparatus as claimed in claim 1, said first and second antennas being sufficiently separated to provide a predetermined amount of electrical isolation from each other.

6. An apparatus as claimed in claim 1, said first and second antennas being sufficiently separately disposed to provide at least 12 decibels of electrical isolation from each other.

7. An apparatus, comprising:
a housing;
a diversity antenna disposed in said housing;
a baseband transceiver disposed in said housing to couple with said diversity antenna;
said diversity antenna comprising:
a first antenna having a ground plane; and
a second antenna having a ground plane;
the first and second antennas being disposed with respect to one another wherein the ground plane of the first antenna and the ground plane of the second antenna each are disposed orthogonally with respect to each other to provide complementary gain patterns combined into an overall diversity gain pattern.

8. An apparatus as claimed in claim 7, further comprising a processor disposed in said housing to couple with said baseband processor.

9. An apparatus as claimed in claim 7, further comprising a host processor disposed exterior to said housing to couple with said baseband transceiver.

10. An apparatus as claimed in claim 7, said first and second antennas being disposed on a common printed circuit board.

11. An apparatus as claimed in claim 7, at least one of said first and second antennas comprising a printed inverted F antenna.

12. An apparatus as claimed in claim 7, at least one relative maximum of one of the gain patterns the occurring at an angle corresponding to a null of the other gain pattern.

13. An apparatus as claimed in claim 7, said first and second antennas being sufficiently separated to provide a predetermined amount of electrical isolation from each other.

14. An apparatus as claimed in claim 7, said first and second antennas being sufficiently separately disposed to provide at least 12 decibels of electrical isolation from each other.

15. An apparatus, comprising:
a first means for transducing energy between electromagnetic energy and current, said first transducing means having a ground plane; and
a second means for transducing energy between a electromagnetic energy and current, said second transducing means having a ground plane;
the first and second transducing means being disposed with respect to one another wherein the ground plane of the first transducing means and the ground plane of the second transducing means each are disposed orthogonally with respect to each other to provide complementary gain patterns combined into an overall diversity gain pattern.

16. An apparatus as claimed in claim 1, said first and second transducing means being disposed on a common printed circuit board.

17. An apparatus as claimed in claim 1, at least one of said first and second transducing means comprising a printed inverted F antenna.

18. An apparatus as claimed in claim 1, at least one relative maximum of one of the gain patterns the occurring at an angle corresponding to a null of the other gain pattern.

19. An apparatus as claimed in claim 1, said first and second transducing means being sufficiently separated to provide a predetermined amount of electrical isolation from each other.

20. An apparatus as claimed in claim 1, said first and second transducing means being sufficiently separately disposed to provide at least 12 decibels of electrical isolation from each other.
